(19) United States
(12) Patent Application Publication
(10) Pub. No.: US 2006/0291248 A1
(43) Pub. Date: Dec. 28, 2006

(54) LIGHT GUIDE PLATE AND RELATED DISPLAY DEVICE

(76) Inventor: Tai-Cherng Yu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,401

(22) Filed: Mar. 21, 2006

(30) Foreign Application Priority Data
Jun. 14, 2005 (CN) 200510035335.8

(51) Int. Cl. F21V 7/04

(52) U.S. Cl. 362/615

(57) ABSTRACT

The present invention provides a light guide plate. The light guide plate includes an incident surface, an upper emission surface and a lower emission surface facing away from the upper emission surface. A plurality of upper V-shaped grooves is defined in the upper emission surface. A plurality of lower V-shaped grooves is defined in the lower emission surface. A width of each of the upper V-shaped grooves is substantially equal to the width of each of the lower V-shaped grooves. A depth of each of the upper V-shaped grooves is substantially smaller than a depth of each of the lower V-shaped grooves. The present invention also provides a display device. The display device includes a first display module, a second display module, at least one light source, with the light guide plate arranged between the first display module and the second display module.

### FIELD OF THE INVENTION

The present invention relates to light guide plates, and particularly to a light guide plate having two facing away emission surfaces and a display device having the same.

### DESCRIPTION OF RELATED ART

In recent years, the mobile telephone function has developed from the initial speech-only service to the supplementary text and image data communication services. Types of mobile telephone include flip type, bar type, folder type, and so on. The folder type telephone has become an in-demand item for global users. To compete in the modern market mobile telephones must have higher display definitions, bigger display screens, be lightweight and have an ergonomic outline.

A typical folder type telephone uses two sets of backlight modules to provide backlight both to illuminate a main display module and also a sub-display module. The main display module is used to display the main information and the sub-display module is used to display secondary information. A great amount of light is needed to illuminate the main display module but only little light is needed to illuminate the sub-display module. As shown in FIG. 1, the light emitted from light sources 37 like LEDs (light-emitting diode) of the display device 30 shines onto the light guide plates 33 and 39, and is then transmitted from the emission surfaces 330 and 390 to illuminate the main display module 35 and the sub-display module 31. However, the above display device 30 not only consumes a lot of power and has an unsatisfactorily long stand-by time, but it also uses a large number of elements in its construction so as to perform the double screen function. This can lead to higher costs and more complicated production and assembly.

What is needed, therefore is to provide a light guide plate and a related display device, which can achieve the double screen function but with lower cost and greater simplicity of assembly.

### SUMMARY OF INVENTION

A light guide plate includes an incident surface, an upper emission surface, and a lower emission surface facing away from the upper emission surface. A plurality of upper V-shaped grooves is defined in the upper emission surface. A plurality of lower V-shaped grooves is also defined in the lower emission surface. A width of each of the upper V-shaped grooves is substantially equal to the width of each of the lower V-shaped grooves. A depth of each of the upper V-shaped grooves is substantially smaller than a depth of each of the lower V-shaped grooves.

A display device includes a first display module, a second display module, at least one light source, and a light guide plate arranged between the first display module and the second display module. The light guide plate includes an incident surface, an upper emission surface, and a lower emission surface facing away the upper emission surface. A plurality of upper V-shaped grooves is defined in the upper emission surface. A plurality of lower V-shaped grooves is defined in the lower emission surface. A width of each of the upper V-shaped grooves is substantially equal to the width of each of the lower V-shaped grooves. A depth of each of the upper V-shaped grooves is substantially smaller than a depth of each of the lower V-shaped grooves.

Unlike in conventional technology, the light guide plate of the invention includes two emission surfaces facing away from each other. The light emitted by the light sources is incident on the light guide plate and is transmitted to the two emission surfaces where it illuminates the first display module and the second display module, so the folder type telephone can use only one set of backlight module to attain the double screen function. The mobile telephone can achieve the same double screen performance but with lower cost and greater simplicity of assembly, to name only two potential advantages.

### BRIEF DESCRIPTION OF DRAWINGS

Many aspects of the light guide plate and the related display device can be better understood with reference to the following drawings. The components in the drawings are not necessarily to scale, the emphasis instead being placed upon clearly illustrating the principles of the present invention. Moreover, in the drawings, like reference numerals designate corresponding parts throughout the several views.

FIG. 1 is a schematic view of a typical display device of a folder type telephone.

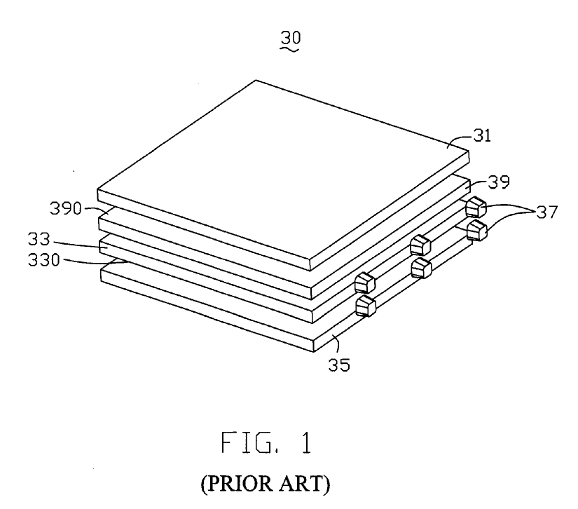

FIG. 2 is an isometric view of a light guide plate in accordance with a first preferred embodiment of the present invention.

FIG. 3 is an enlarged view of a circled portion of the light guide plate of FIG. 2.

FIG. 4 is an exploded, isometric view of a display device having the light guide plate of FIG. 2 in accordance with an exemplary embodiment.

FIG. 5 is an isometric view of an alternative light guide plate.

### DETAILED DESCRIPTION

Reference will now be made to the drawing figures to describe the preferred embodiment of the present invention in detail.

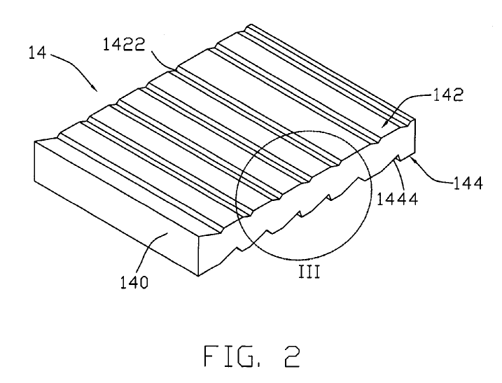

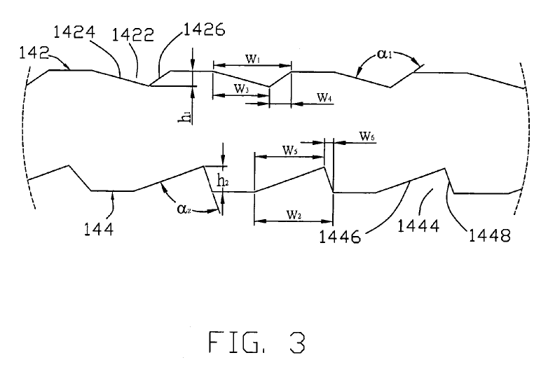

Referring to FIG. 2 and FIG. 3, a light guide plate 14 according to a first preferred embodiment is shown. The light guide plate 14 is a substantially flat sheet having a uniform thickness. The light guide plate 14 includes an incident surface 140, an upper emission surface 142, and a lower emission surface 144. The upper emission surface 142 is joined with the incident surface 140. The lower emission surface 144 faces away from the upper emission surface 142. A plurality of upper V-shaped grooves 1422 is arranged in the upper emission surface 142 in a direction substantially parallel to the incident surface 140. A plurality of lower V-shaped grooves 1444 is arranged in the lower emission surface 144 in a direction substantially parallel to the incident surface 140.

Referring to FIG. 3, a width of the upper V-shaped groove 1422 and a width of lower V-shaped groove 1444 are respectively labeled with reference characters W₁ and W₂. A depth of the upper groove 1422 and a depth of lower V-shaped groove 1444 are respectively labeled with reference characters h₁ and h₂. The vertex angle of the upper V-shaped groove 1422 and the vertex angle of the lower V-shaped groove 1444 are denoted with the reference characters α₁ and α₂. The value of W₁ is equal to value of W₂, the value of h₁ is smaller than the value of h₂ and the value of α₁ is larger than the value α₂. The numerical value of W₁ is smaller than 5 microns and W₂ is smaller than 5 microns. The numerical value of α₂ is above 0° and below 90°. The numerical value of α₁ is larger than 90° and less than 180°.

Each of upper V-shaped grooves 1422 defines a first surface 1424 and a second surface 1426. The first surface 1424 is nearer to the incident surface 140 than the second surface 1426. A width of the first surface 1424 is labeled with a character W₃. A width of the second surface 1426 is labeled with a character W₄. The numeral of W₃ is larger than that of W₄.

Each of lower V-shaped grooves 1444 defines a third surface 1446 and a fourth surface 1448. The third surface 1446 is nearer to the incident surface 140 than the fourth surface 1448. A width of the third surface 1446 is labeled with a character W₅. A width of the fourth surface 1448 is labeled with a character W₆. The numeral of W₅ is larger than that of W₆.

The upper V-shaped grooves 1422 are arranged discretely in the upper emission surface 142. The lower V-shaped grooves 1444 are arranged discretely in the lower emission surface 144. The base point of each upper V-shaped groove 1422 and the vertex point of lower each V-shaped groove 1444 are spaced from each other. Namely, the base point of each upper V-shaped groove 1422 is configured substantially between the vertex points of each adjacent lower V-shaped groove 1444.

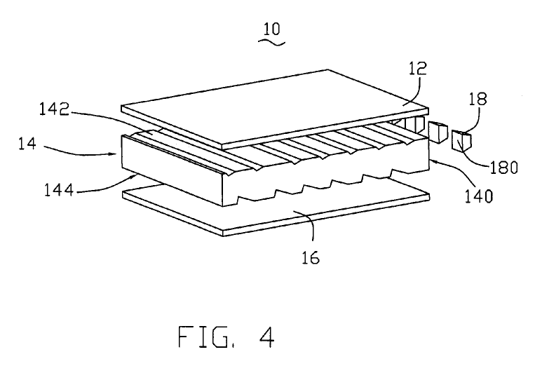

Because the length of h₁ is less than the length of h₂, the amount of light incident on the upper V-shaped grooves 1422 is smaller than the amount incident on the lower V-shaped grooves 1444. As such, the exiting light from the upper emission surface 142 is more than the light exiting the lower emission surface 144. The upper emission surface 142 therefore can provide more light to illuminate the first display module 12 (as shown in FIG. 4) than the lower emission surface 144 provides to illuminate the second display module 14 (as shown in FIG. 4).

Referring to FIG. 4, a display device 10 in accordance with a second embodiment is shown. The display device 10 includes a first display module 12, a second display module 16, a light guide plate 14, and a plurality of light sources 18.

The light source 18 could be an LED, an ELD (electroluminescent device) or any other appropriate light source. A luminous surface 180 of each light source 18 is configured facing the incident surface 140 of the light guide plate 14.

The light guide plate 14 is located between the first display module 12 and the second display module 16. The first display module 12 faces the upper emission surface 142. The second display module 16 faces the lower emission surface 144.

The light emitted from the light sources 18 is incident on the light guide plate 14 and is transmitted to and then exits from the upper emission surface 142 and the lower emission surface 144, these surfaces illuminating the first display module 12 and the second display module 16 respectively.

In another embodiment, the light guide plate of the invention could be wedge-shaped. The material of the light guide plate can be polycarbonate (PC), polymethyl methacrylate (PMMA) or any other appropriate resin material.

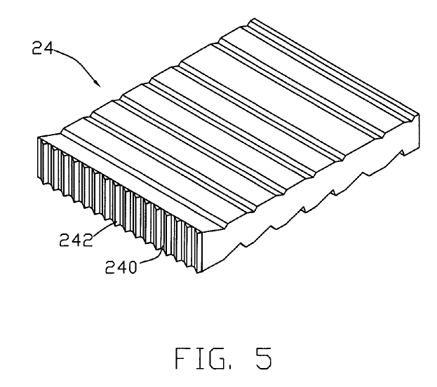

Alternatively, as shown in FIG. 5, the light guide plate 24 could further include a plurality of third microstructures 242 e.g. prisms formed on the incident surface 240 to increase the uniformity of the incident light. The third microstructure 242 could be pyramidal prisms or any other appropriate shape.

The display device 10 further comprises one or more reflecting covers surrounding the respective light sources 18 to increase the utilization of the light emitted by the light sources 18. The reflecting covers will preferably be substantially arc-shaped.

The light guide plate 14 of the first preferred embodiment has two emission surfaces 142 and 144 facing away from each other. The light emitted from the light sources onto the light guide plate and is transmitted to and then exits from the two emission surfaces. The exiting light illuminates both the first display module and the second display module. The power of the light transmitted from the two emission surfaces 142 and 144 is controlled by the size and shape of upper V-shaped grooves 1422 and the lower V-shaped grooves 1444 respectively.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A light guide plate, comprising:
an incident surface;
an upper emission surface;
a lower emission surface facing away from the upper emission surface;
a plurality of upper V-shaped grooves defined in the upper emission surface; and
a plurality of lower V-shaped grooves defined in the lower emission surface; wherein
a width of each of the upper V-shaped grooves is substantially equal to the width of each of the lower V-shaped grooves, a depth of each of the upper V-shaped grooves is substantially smaller than a depth of each of the lower V-shaped grooves.

2. The light guide plate as claimed in claim 1, wherein the width of each of the upper V-shaped grooves and the width of each of the lower V-shaped grooves are less than about 5 microns.

3. The light guide plate as claimed in claim 1, wherein the depth of each of the upper V-shaped grooves and the depth of each of the lower V-shaped grooves are less than about 5 microns.

4. The light guide plate as claimed in claim 1, wherein the light guide plate is one of a flat sheet having a uniform thickness and a wedge-shaped block.

5. The light guide plate as claimed in claim 1, wherein the material of the light guide plate is one of polycarbonate and polymethyl methacrylate.

6. The light guide plate as claimed in claim 1, further comprising a plurality of prisms arranged on the incident surface.

7. The light guide plate as claimed in claim 1, wherein each of upper V-shaped grooves defines a first surface and a second surface, the first surface is nearer to the incident surface than the second surface, a width of the first surface is larger than that of the second surface.

8. The light guide plate as claimed in claim 1, wherein each of lower V-shaped grooves defines a third surface and a fourth surface, the third surface is nearer to the incident surface than the fourth surface, a width of the third surface is larger than that of the fourth surface.

9. A display device, comprising:
a first display module;
a second display module;
at least one light source; and
a light guide plate arranged between the first display module and the second display module, the light guide plate comprising
an incident surface;
an upper emission surface;
a lower emission surface facing away from the upper emission surface;
a plurality of upper V-shaped grooves defined in the upper emission surface; and
a plurality of lower V-shaped grooves defined in the lower emission surface; wherein
a width of each of the upper V-shaped grooves is substantially equal to the width of each of the lower V-shaped grooves, a depth of each of the upper V-shaped grooves is substantially smaller than a depth of each of the lower V-shaped grooves.

10. The display device as claimed in claim 9, wherein the width of each of the upper V-shaped grooves and the width of each of the lower V-shaped grooves are less than about 5 microns.

11. The display device as claimed in claim 9, wherein the depth of each of the upper V-shaped grooves and the depth of each of the lower V-shaped grooves are less than about 5 microns.

12. The display device as claimed in claim 9, wherein each of upper V-shaped grooves defines a first surface and a second surface, the first surface is nearer to the incident surface than the second surface, a width of the first surface is larger than that of the second surface.

13. The display device as claimed in claim 9, wherein each of lower V-shaped grooves defines a third surface and a fourth surface, the third surface is nearer to the incident surface than the fourth surface, a width of the third surface is larger than that of the fourth surface.

14. The display device as claimed in claim 9, wherein the shape of the light guide plate is one of a flat sheet having a uniform thickness and a wedge-shaped block.

15. The display device as claimed in claim 9, wherein the material of the light guide plate is one of polycarbonate and polymethyl methacrylate.

16. The display device as claimed in claim 9, further comprising a plurality of prisms arranged on the incident surface.

17. The display device plate as claimed in claim 9, wherein the light source is one of a light-emitting diode and an electroluminescent device.

18. The display device plate as claimed in claim 9, further comprising a plurality of reflecting covers surrounding the respective light sources.
